(19) United States
(12) Patent Application Publication
(10) Pub. No.: US 2016/0345628 A1
(43) Pub. Date: Dec. 1, 2016

(54) ELECTRONIC CIGARETTE AND CIGAR CHARGING AND OPERATING SYSTEMS INTEGRATION WITH VARIOUS CELL PHONE AND TABLET TYPES USING A COMMON CASE

(71) Applicant: Arash Abdollahi Sabet, Walnut Creek, CA (US)

(72) Inventor: Arash Abdollahi Sabet, Walnut Creek, CA (US)

(21) Appl. No.: 15/116,822

(22) PCT Filed: Feb. 24, 2015
(86) PCT No.: PCT/US15/17249

§ 371 Date: Aug. 4, 2016

Related U.S. Application Data
(60) Provisional application No. 61/966,527, filed on Feb. 24, 2014.
(60) Provisional application No. 62/124,227, filed on Dec. 12, 2014.

(51) Int. Cl. A24F 47/00; A24F 15/18; H02J 7/00; H04M 1/725; H04B 1/3888

(52) U.S. Cl. CPC A24F 47/008; H04M 1/72527; H04B 1/3888; H02J 7/0021; H02J 7/0044; A24F 15/18; G06K 7/1413

(57) ABSTRACT

The present invention describes a common case that can hold, protect, and recharge both one or more electronic cigarettes and/or electronic cigars (e-cigs) and either a cell phone or a tablet computer simultaneously with a single external battery charger that plugs into a port on the common case. Once one or more e-cigs are integrated in this way using a common case with a cell phone or tablet, a number additional features can be achieved that make the user's daily routine easier, more productive, and manageable. An example of such feature is to share the total battery power available in his/her cell phone or tablet with the battery power in his/her e-cig so that battery power in the e-cig can be used as a supplemental power source to sustain operation of the cell phone on days when call activity is high and smoking activity is low (or vice versa).

### CROSS REFERENCES TO RELATED APPLICATIONS

This application claims the benefit of U.S. Provisional Patent Application Ser. No. 61/966,527 filed Feb. 24, 2014, titled ELECTRONIC CIGARETTE CHARGING AND OPERATING SYSTEMS INTEGRATION WITH VARIOUS CELL PHONE AND TABLET TYPES USING A COMMON CASE and U.S. Provisional Patent Applications Ser. No. 62/124,227 filed Dec. 12, 2014, titled METHOD AND APPARATUS FOR ELECTRONIC CIGARETTE MODULES SUITABLE FOR INTEGRATION INTO VARIOUS MODULAR SMARTPHONES AND MODULAR TABLETS, the contents of which are hereby incorporated by reference herein.

### BACKGROUND OF THE INVENTION

1. Field of the Invention

This invention relates to reducing the number of discrete personal electronic devices a user must carry and periodically recharge by employing a common protective case to hold, protect, and recharge both a cell phone or tablet computer and one or more rechargeable electronic cigarettes and/or electronic cigars and to support and monitor the usage of these electronic cigarettes and/or electronic cigars. Since the electronic cigarette(s) and/or cigars in the common case may include rechargeable batteries or some other electrical storage capabilities, such as an ultra-capacitor, their stored electrical energy can, if needed, be used to recharge the main battery for the phone or tablet or directly operate these devices.

2. Description of Related Art

The electronic cigarette and related electronic cigar (both subsequently referred to as e-cigs) was invented in 2003 by Lik Hon in China. Hon's patent was issued in 2013 as U.S. Pat. No. 8,511,312 B2. The e-cig described therein is a device that has a physical appearance similar to a regular cigarette containing tobacco. However, the e-cig does not normally contain any tobacco. Rather, it houses a small cartridge (chamber) holding a fluid solution typically containing approximately 1% nicotine in a propylene glycol based solution that is heated and atomized using electrical power from an internal battery when the user inhales air through the e-cig. Of course, the concentration of nicotine can be varied or even eliminated based on the user's preference. And various flavorings can be added to the fluid solution such as mint, cinnamon, or a selection of fruits. It should also be mentioned that other chemicals like tetrahydrocannabinol (THC, the most active ingredient in cannabis) can also be added to the solution but use of this compound has been banned in a number states and countries.

The experience using an e-cig (which will henceforth be referred to as e-smoking) is quite similar to smoking a regular tobacco cigarette or cigar. Even the visual experience has been simulated. For example, the atomized propylene glycol solution has an appearance similar to regular cigarette smoke. And many of the present e-cigs have a red light emitting diode (LED) near their distal tips that turns on when the user inhales to simulate the appearance of a conventional lit cigarette or cigar. However, there is a major benefit to the user of an e-cig because it eliminates all of the carcinogenic tars associated with burning tobacco. And since no burning actually takes place when using an e-cig, there is no possibility of inadvertently starting a fire. In view of these and other benefits, it is not surprising that sales of e-cigs have grown rather rapidly since it was conceived in 2003. Presently, multiple brands of e-cigs are sold, where permitted, in most drug stores in the U.S. and other retail outlets where conventional cigarettes and cigars are sold.

Most e-cigs are comprised of two basic cylindrical components that can be easily assembled by the user simply by screwing them together. One component contains a battery, which may be either for single use or rechargeable, while the other component contains a cartridge of, typically, a nicotine fluid solution and a battery powered atomizer to convert this solution into a mist when an e-smoker inhales through an e-cig. This second component is usually referred to as the “cartridge”—but sometimes it is also called the “cartomizer” (a recently coined word signifying the combination of a fluid cartridge and an atomizer). This component is often disposed of after the fluid in the cartridge has been depleted. But, some cartridges can be refilled and reused.

Although e-cigs come in many different colors and styles, the typical appearance is that of a regular tobacco cigarette or cigar. For example, the battery in a typical electronic cigarette often takes the form of a white cylinder simulating the white paper that wraps the tobacco in a regular cigarette and a tan colored cartridge that simulates a filter on the proximal end of a regular cigarette. When used, a single electronic cigarette provides the e-smoker approximately as many puffs (a normal inhale-exhale cycle) as an entire pack of regular cigarettes (there are typically 20 cigarettes per pack). So, an e-cigarette user typically carries only a single battery component and one or several cartridges in a pack or case that often has the appearance of a regular cigarette pack or case. However, if the user chooses to use an e-cigarette with a battery component that is rechargeable, and therefore more economical to use, he/she must either carry a battery charger or face the possibility that the e-cigarette's battery will run too low before returning to a location where a charger is available. The same situation applies for users of e-cigars, although they typically have four or five times the number of puffs as compared to an e-cigarette due to their larger battery. So, the logistics of porting both e-cigs and, possibly, a battery charger can become an inconvenience if not an annoyance for the user.

It would clearly be a convenience to the user of a rechargeable e-cig not to have to port a charger dedicated to this device and, in fact, it would be even a greater convenience if the user did not have to carry a separate pack or case dedicated to his/her e-cig. It would also be advantageous to the user to be able to draw upon the battery power available in a cell phone or tablet to recharge his/her e-cig. Alternatively it would also be advantageous for the user to be able to use the battery power (or other stored electrical power) in the e-cig as a supplemental power source to sustain operation of the cell phone on days when call activity is high and smoking activity is low. Finally, it would be of value to some e-cig users to have the ability to automatically monitor their daily e-smoking activity using their cell phone or tablet, possibly to assist in reducing nicotine consumption or in support of some other desired behavioral modification.

See also U.S. Pub. Nos. 2005/0016550, 2006/0196518, 2009/0272379, 2013/0284192, 2013/0319439, 2013/0340775, and 2013/0220315.

### SUMMARY OF THE INVENTION

With approximately 150 million smart cell phones presently in use in the U.S. as well as a growing use of tablet computers (subsequently referred to as simply as “tablets”), it is likely that a substantial majority of e-cig users also carry cell phones and/or tablets when they move about during their daily activities. The novel concept associated with the present invention is to include within a common carrying case all of the necessary interfacing electronics to integrate the functionality of the both the e-cig and cell phone or tablet to optimizes the user's convenience.

The present invention describes a common protective case to hold, protect, and recharge both a cell phone or tablet computer and one or more rechargeable e-cigs and to support and monitor the usage of these e-cigs. And on command of the user, the energy available in the e-cig's battery can be transferred to the main battery in the cell phone or tablet (or vice versa). Usage information such as the charge level of the e-cig's battery, the type of fluid and fluid level in the e-cig's cartridge, and a historical record of the amount of a user's e-cig smoking can be shown on the display screen associated with a cell phone or tablet using a specialized user application (USE APP). This USE APP can also provide helpful support in ordering e-cig smoking materials, managing the e-smoker's daily use, and making the user's daily routine easier and/or more productive. For example, the USE APP could monitor e-cig usage, and automatically order replacement cartridges to replenish stocks at levels pre-determined by the user. It could also provide a display on the screen of the cell phone or tablet showing current and/or historical information on e-cig usage that may be helpful to the user in modifying his/her e-smoking habits.

One particularly useful feature is to offer the user the ability to share the total battery energy available in his/her cell phone or tablet with the battery energy (or other electrically stored energy) in his/her e-cig so that, for example, battery energy in the e-cig could be used as a supplemental energy source to sustain operation of the cell phone on days when call activity is high and smoking activity is low (or vice versa). Another feature would be to offer the user the ability to quickly check the charge status of his/her e-cig similar to the way the battery charge status of a cell phone or tablet can now be monitored. Finally, it would be of value to some e-cig users to have the ability to automatically monitor their daily e-smoking activity using the processing power already in their smartphone or tablet, possibly to assist in reducing nicotine consumption or in support of some other behavioral modification activity. Such features can be realized in one or more specialized applications (USE APPS) that can enhance an e-smoker's overall experience.

While the features in the common case introduced in this patent application for holding, protecting, charging, and communicating usage data that is shared between one or more e-cigs and a cell phone or tablet is novel, there is some related prior art that will now be mentioned. One is a cell phone case that is produced and sold by Mophie, LLC under the trade name “Juice Pack” (Mophie, LLC, 6244 Technology Ave., Kalamazoo, Mich. 49009 with a web site at www.mophie.com) that includes a rechargeable battery that is integrated into the case structure and can be used to supplement the cell phone's battery. In use, both the cell phone and the external supplemental battery can be simultaneously charged so that the operating time for the cell phone/external battery combination on a single charge exceeds that of a stand-alone cell phone. This case has no provision for including or containing any other components or devices such as an e-cig.

There is another cell phone case covered by U.S. Patent Pub. No: U.S. 2012/0302294 titled ILLUMINATED CELL PHONE CASE that also includes a supplemental battery in the case for purposes of illumination. And there are a variety of other cell phone cases that include batteries to support special features, including a shocking feature for personal defense (WO 2013126871 A1). However, none of these special purpose case designs include the feature of holding or charging an e-cig.

Another example of prior art is a cell phone case sold under the name iHit (found on the Internet at “theihit.com”) that includes a hidden pocket for storing, for example a single regular cigarette or a small ceramic pipe. There is no charging capability provided to the stored cigarette or pipe. The iHit case also includes a second pocket for storing tobacco but this case does not have any provision for including one or more e-cigs.

The following drawings and the associated discussions provide further information on the design and operation of a common protective case to hold, protect, and recharge both a cell phone or tablet computer and one or more rechargeable e-cigs and to support and monitor the usage of these e-cigs.

### BRIEF DESCRIPTION OF THE DRAWINGS

The above SUMMARY OF THE INVENTION as well as other features and advantages of the present invention will be more fully appreciated by reference to the following detailed descriptions of illustrative embodiments in accordance with the present invention when taken in conjunction with the accompanying drawings, wherein:

FIG. 1A is a perspective view of the two basic components that make up an e-cigarette.

FIG. 1B is a perspective view of the same two basic components shown in FIG. 1A screwed together to make an e-cigarette.

FIG. 1C is a perspective view of the two basic components that make up an e-cigar.

FIG. 1D is a perspective view of the same two basic components shown in FIG. 1C screwed together to make an e-cigar.

FIG. 2A is a perspective view of common case that can hold a single e-cig and a Samsung Galaxy cell phone in the rectangular cavity sized to fit this phone.

FIG. 2B is a front perspective view of common case that can hold a single e-cigar and an Apple iPhone 6 in the rectangular cavity sized to fit this phone.

FIG. 2C is a back perspective view of common case shown in FIG. 2B that can hold a single e-cigar and an Apple iPhone 6.

FIG. 3A is an exploded perspective view of an alternate common case made from two parts that fit around an Apple iPhone 5 suitable for holding two e-cigarettes.

FIG. 3B shows the same common case shown in FIG. 3A that is fully assembled and holding an Apple iPhone 5.

FIG. 3C shows a perspective view of back side of the common case shown in FIG. 3B with two e-cigs pressed into place.

FIG. 3D is an exploded perspective view of an alternate common case made from two parts that fit around an Apple iPhone 6 suitable for holding one e-cigar.

FIG. 3E shows the same common case shown in FIG. 3D that is fully assembled and holding an Apple iPhone 6.

FIG. 3F shows a perspective view of back side of the common case shown in FIG. 3E with one e-cigar pressed into place.

FIG. 4 is an electrical block diagram showing one particular embodiment of a charging circuit that can simultaneously recharge both a cell phone or tablet and an e-cig from a single external source. Also shown are data connections that permit the cell phone or table to interact with and alter the function of the case electronics.

FIG. 5 is an electrical block diagram showing how the e-cig can be charged directly from a cell phone.

FIG. 6A shows a feature added to the common case that is used to visually check the electrical charge status of the e-cig's battery.

FIG. 6B shows the display associated with an application (USE APP) added to an Apple iPhone 6 in a common case that is used to visually check the electrical charge status of the e-cig's battery as well as the total number of puffs supplied by the e-cig.

FIG. 7 is a perspective view of the printed circuit board and some of the related electrical components shown in FIG. 4.

FIG. 8 is and electrical block circuit diagram that includes a supplemental rechargeable battery built into the common case.

FIG. 9A is a perspective view showing a design feature to facilitate the retention and removal of an e-cigarette from a common case.

FIG. 9B is a perspective view showing another design feature to facilitate the retention and removal of an e-cigarette from a common case.

FIG. 9C is a perspective view showing yet another design feature to facilitate the retention and removal of an e-cigarette from a common case.

FIG. 10A is a perspective view showing a printed circuit board that includes a means of retaining and charging an e-cigarette with a micro-USB connector.

FIG. 10B is a perspective view showing of a printed circuit board that includes a means of retaining and charging an e-cigar with a micro-USB connector.

FIG. 10C is a perspective view showing the printed circuit board in FIG. 10B that identifies the various components associated with retaining and charging an e-cigar.

FIG. 11A is drawing of a standard micro-USB connector that is commonly used with Samsung Galaxy 5 cell phones and other Android phones, for connecting between these phones and a common case, and for connecting the common case to an external battery charger.

FIG. 11B is drawing of a proprietary connector known as a Lightening Connector, that is used with Apple iPhone 6.

FIG. 12A shows an exploded perspective view of an alternative common case that has a detachable e-cigarette module.

FIG. 12B Shows an Apple iPhone 6 fully inserted into the common case forming a case/phone subassembly while the detachable e-cigarette module 653 remains unattached.

FIG. 12C shows a perspective view of the common case, the iPhone 6, and the detachable e-cigarette module all joined together to form a completed assembly.

FIG. 12D is a perspective back view of the completed assembly shown in FIG. 12C showing a slider to assist in removal of the e-cigarette from the module.

FIG. 12E is the same perspective view of the e-cig module shown in FIG. 12D with the slider moved fully to the right so as to cause the e-cig components to partially extend out of the e-cig module.

FIG. 12F is a perspective view of the internal portion of the detachable e-cigarette module shown in FIG. 12A.

FIG. 12G is a perspective view similar to that in FIG. 12F but with the e-cigarette components removed.

FIG. 13 is a cross-sectional view of the proximal end of an e-cig cartridge showing an optical sensor means for determining the fluid level in a solution container located inside of an e-cig cartridge.

FIG. 14 is a perspective view showing an arrangement for an alternative means for measuring the amount of fluid solution remaining in the e-cig cartridge.

FIG. 15 shows a barcode printed on the outer circumference of an e-cig cartridge.

### DETAILED DESCRIPTION OF THE DRAWINGS

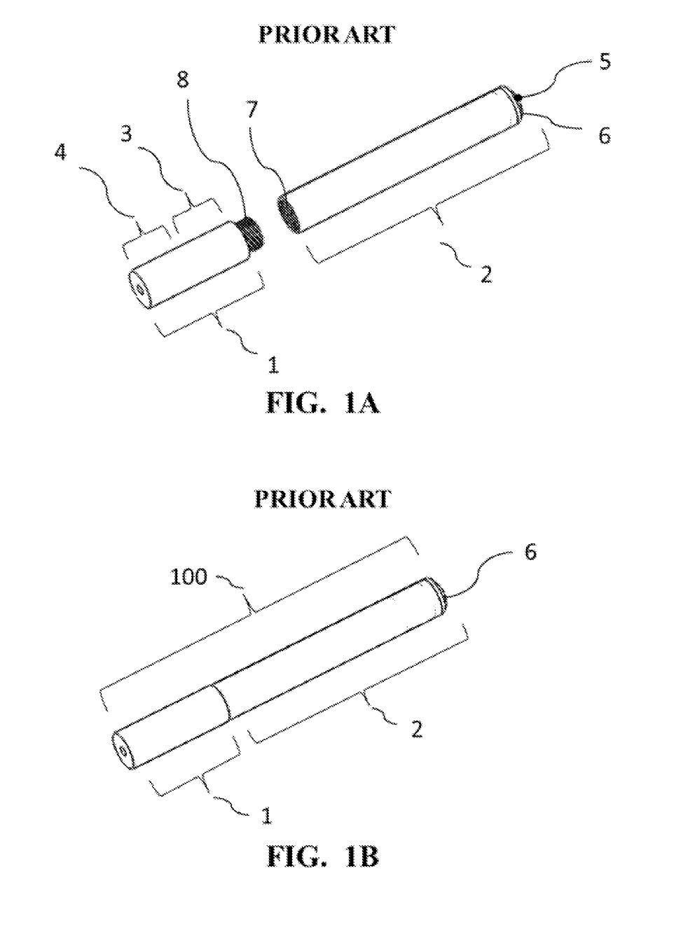

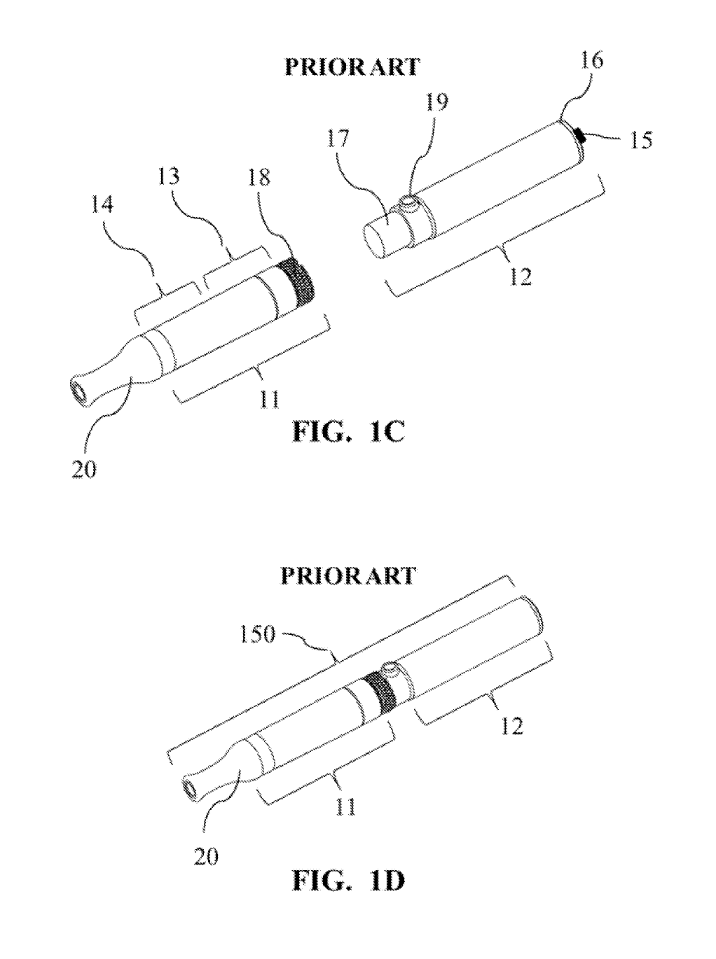

Referring to FIG. 1A, an e-cigarette is made up of two main components, a cartridge component 1 and a battery component 2 that are not assembled in this figure. The cartridge component 1 contains two subcomponents, a solution chamber 3 and an atomizer 4. The distal tip of the e-cigarette is frequently (but not always) covered with a diffuse plastic cap 6 to simulate a regular cigarette ash enclosing a red LED 5 that is turned on when the user inhales through the e-cigarette. The two basic e-cigarette components 1 and 2 are screwed together with a male screw thread 8 that is integral with the cartridge component 1 and a female screw thread that is integral with the battery component 2. There are a number of other internal components inside of the e-cigarette that are not shown because they are not material to this patent application. These internal components include, amongst others, a heating coil to heat the solution before atomization, and a battery voltage regulator.

FIG. 1B shows the cartridge component 1 and the battery component 2 shown in FIG. 1A screwed together to form a fully assembled e-cigarette 100.

FIG. 1C shows an exploded view of an e-cigar that is similar in construction to the e-cigarette shown in FIG. 1A but somewhat larger in size. The e-cigar is made up of two main components, a cartridge component 11 and a battery component 12. The cartridge component 11 contains two subcomponents, the solution cartridge 13 and the atomizer 14. The distal tip of the e-cigarette is frequently (but not always) covered with a diffuse plastic cap 16 to simulate a regular cigar ash enclosing a red LED 15 that is turned on when the user inhales through the e-cigar. The two basic e-cigar components 11 and 12 are screwed together with a male screw thread 18 that is integral with the cartridge component 11 and a female screw thread 17 that is integral with the battery component 12. The e-cigar has an optional external button switch 19 that can be activated by the user to cause atomization (vaporization) of some of the fluid in the solution cartridge 13. The e-cigar usually has an optional mouthpiece 20 to transition between the larger diameter cartridge component and the smaller diameter of the user's mouth. There are a number of other internal components inside of the e-cigar that are not shown because they are not material to this patent application. These internal components include, amongst others, a heating coil to heat the solution before atomization and a battery voltage regulator.

FIG. 1D shows the cartridge component 11 and the battery component 12 shown in FIG. 1C screwed together to form a fully assembled e-cigar 150.

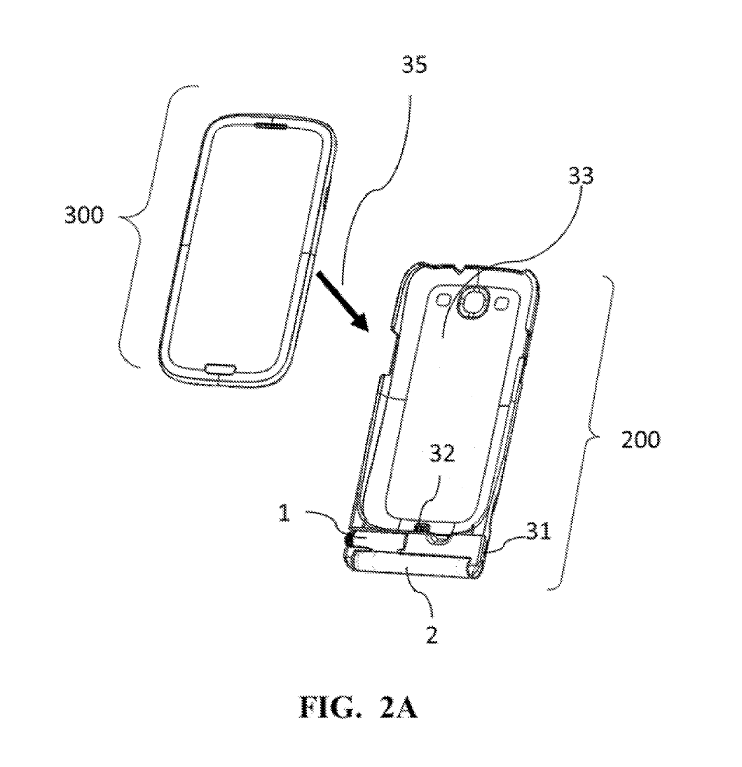

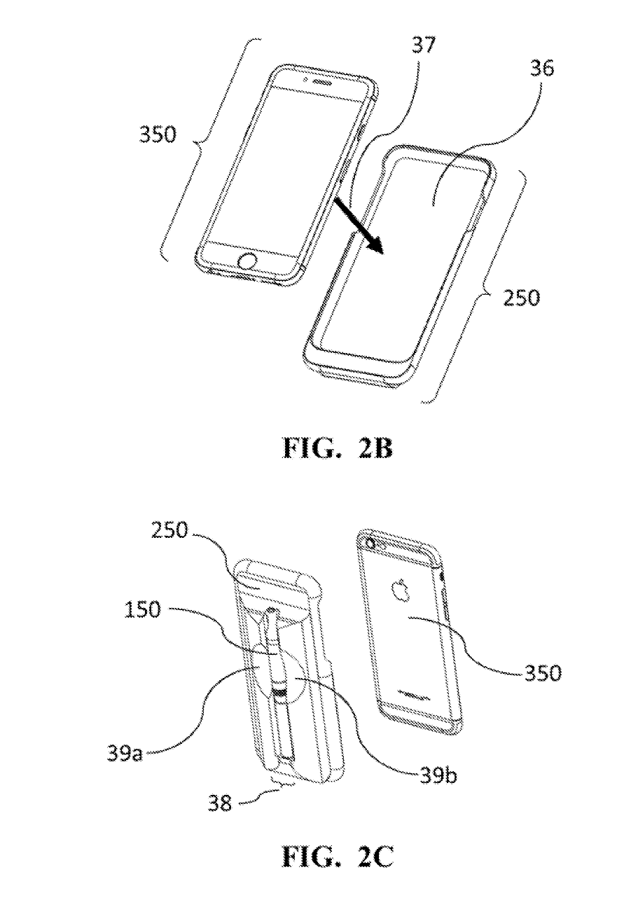

FIG. 2A is a perspective view of a common case 200 made by injection molding of an impact resistant plastic that is designed to hold, protect, and recharge an e-cigarette battery 2 and a cell phone 300. The cell phone 300 is inserted into the rectangular shaped cavity 33 in the common case 200 following the direction of the arrow 35. The common case 200 also holds and protects the cartridge component 1.

FIG. 2B is a perspective front view of an alternative common case 250 made by injection molding of an impact resistant plastic that is designed to hold, protect, and recharge an e-cigar 150 (shown in FIG. 2C) and a cell phone, such as the Apple iPhone 6 350, shown in this figure. The cell phone is inserted into the rectangular shaped cavity 36 in the common case 250 following the direction of the arrow 37.

FIG. 2C is a perspective back view of the common case 250 shown in FIG. 2B. The e-cigar 150 can be seen in this view located in a cavity 38 formed on the back of the common case 250. The transverse opening of the cavity 38 is slightly smaller than the diameter of the e-cigar 150. But, the cavity, itself, is sized to comfortably fit the entire e-cigar once it is fully inserted into place. The user can press fit his/her e-cigar 150 into the cavity 38 and it will be firmly held in place by the narrow restrictive cavity opening. To remove the e-cigar 150 from the cavity, there are two zones of relief 39a and 39b on the sides of the cavity 38 so that the user can get a firm finger grip on the e-cigar 150 and pull it free from the cavity 38 when he/she is ready to use the e-cigar.

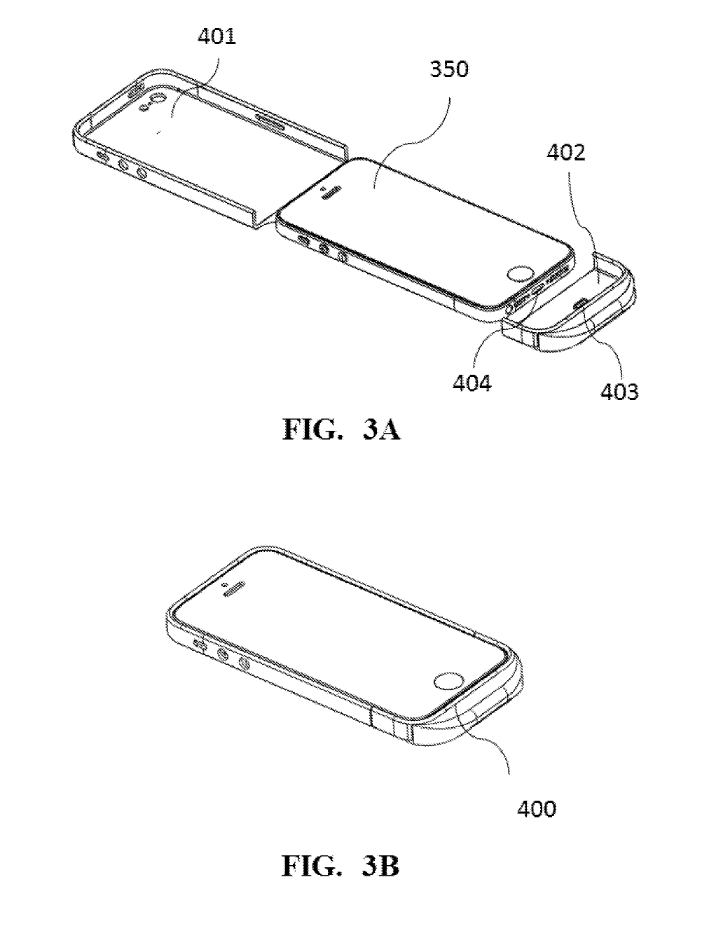

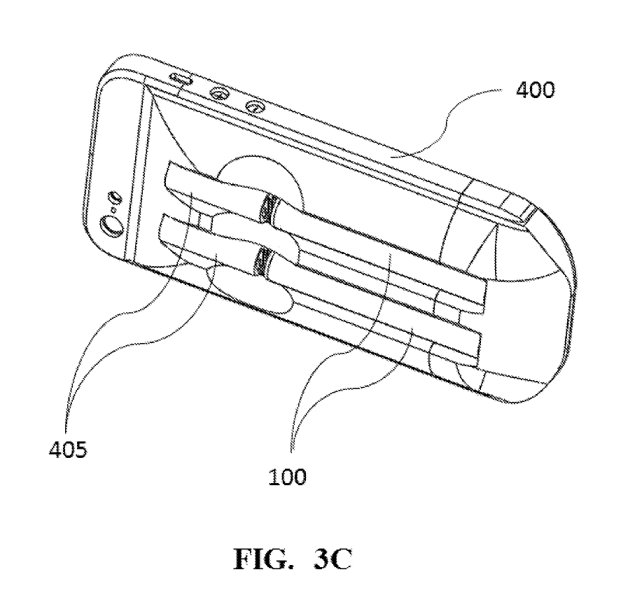

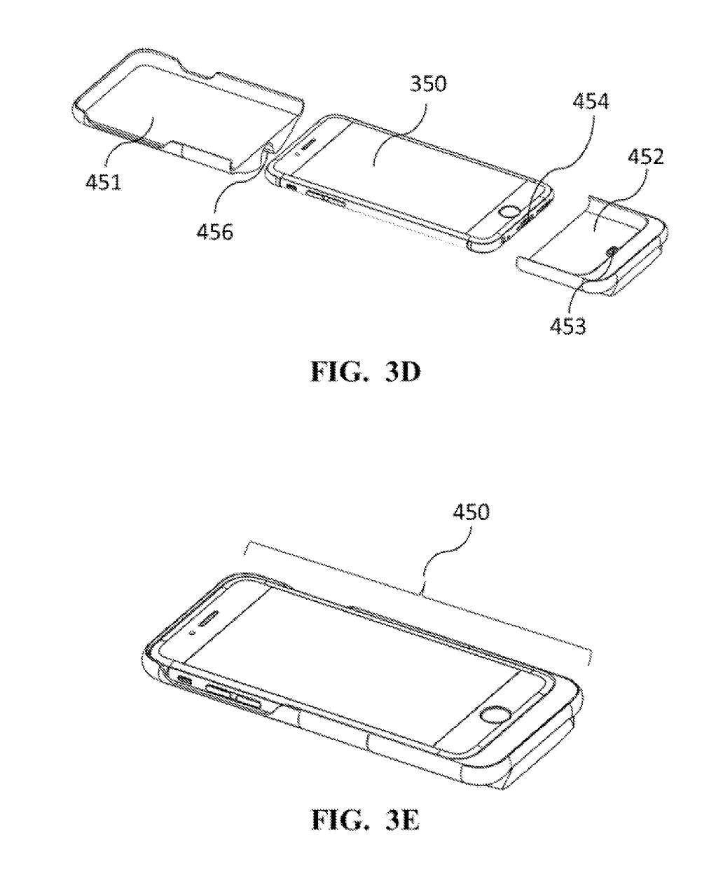

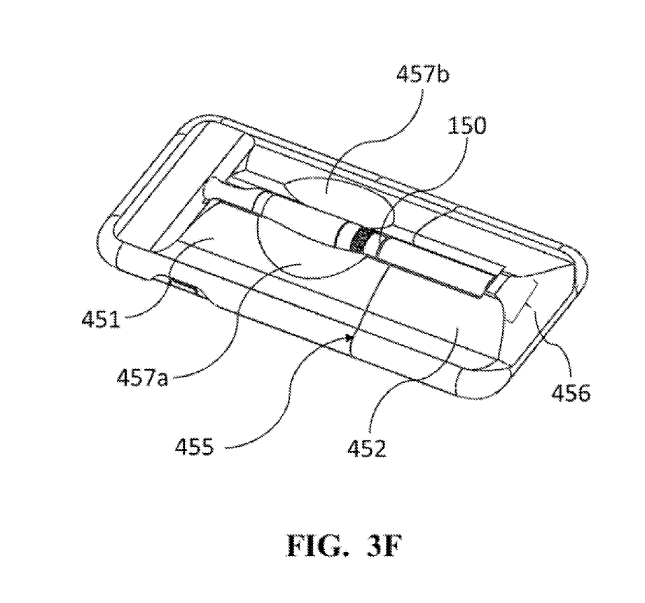

FIG. 3A is an exploded perspective view showing an example of another common case design. In this instance the case, also made by injection molding of an impact resistant plastic, consists of two parts, a top part 401 and a bottom 402 that slide together over an Apple iPhone 6 350. The bottom part of the common case 402 includes an internal male electrical connector 403 that mates with a female connector 404 located on the bottom side of the iPhone 6. Assembling a two-part case, such as the one shown in this figure, by sliding these parts together over an iPhone 6 is advantageous to avoid damage of the male connector 403 and female connector 404 parts.

FIG. 3B shows the common case 400 made up of parts 401 and 402 shown in FIG. 3A that is fully assembled.

FIG. 3C shows two e-cigarettes 100 inserted into two recessed cavities 405 on the back of common case 400.

FIG. 3D is an exploded front perspective view showing an example of another common case similar to the one Shown in FIGS. 3A, 3B, and 3C that is suitable for holding an e-cigar rather than e-cigarettes. In this instance the case, also made by injection molding of an impact resistant plastic, consists of two parts, a top part 451 and a bottom part 452 that slide together over an Apple iPhone 6 350. The bottom part of the common case 452 includes an internal male electrical connector 453 that mates with a female connector 454 located on the bottom side of the iPhone 6 350. A channel 456 formed on the back side of the top part 451 to hold an e-cigar 150 can be seen in this figure.

FIG. 3E shows the common case 450 made up of parts 451 and 452 shown in FIG. 3D that is fully assembled.

FIG. 3F shows an e-cigar 150 inserted into a recessed cavity 456 on the back of common case 450. The parting line 455 between the top part 451 and bottom part 452 of the common case can be seen in this view. The user can press fit his/her e-cigar 150 into the cavity 456 and it will be firmly held in place by the narrow restrictive cavity opening. To remove the e-cigar 150 from the cavity, there are two zones of relief 457a and 457b on the sides of the cavity 456 so that the user can get a firm finger grip on the e-cigar 150 and pull it free from the cavity 456 when he/she is ready to use the e-cigar.

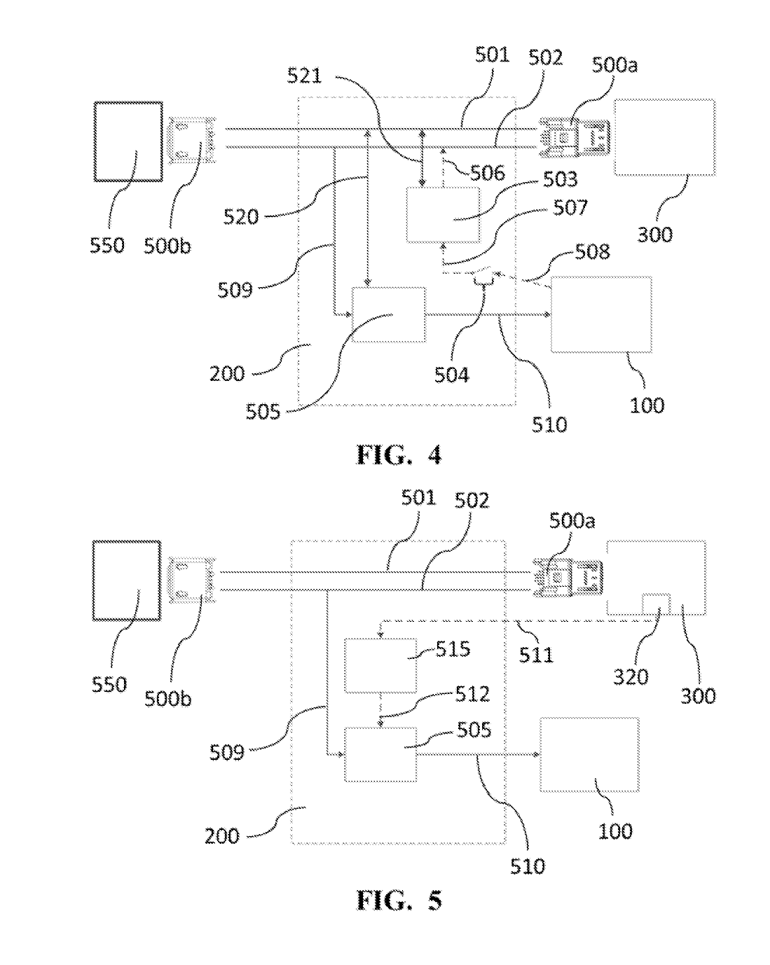

FIG. 4 is an electrical block circuit diagram showing one particular embodiment of a charging circuit contained within a common case 200 that can simultaneously recharge both a cell phone 300 or tablet (not shown) connected to the common case with electrical connector 500a and an e-cigarette 100 from a single external source 550. In operation, an external micro-USB connector 500b receives both charging power on a pair wires 502 (one having positive polarity and the other negative, ground, polarity) and digital data on a pair of wires 501. Some of the power on wires 502 is tapped (split off) onto a pair of wires 509 that are directed to charging circuit 505 for the e-cigarette. The output wires 510 from charging circuit 505 are directed to the e-cig 100 to complete the charging path. There is also an alternate charging path to charge the cell phone 300 when no external electrical power is available. This alternate path taps the battery power of the e-cig and directs it to the cell phone via a pair of wires 508, a phone charging switch 504, wires 507, and cell phone smart voltage regulator 503 (that includes a voltage booster to achieve 5 Volts that is typically required to charge cell phones) and tablets and wires 521 and 501. This smart voltage regulator 503 also has the capability to communicate data to the smart phone 300 via wires 506 and 502. An electrical circuit similar to the one shown in FIG. 4 is used to charge both e-cigarettes and e-cigars and other types of cell phones, including the iPhone 6. However, the iPhone 6 requires a proprietary connector rather than the micro-USB connector 500b shown in FIG. 4.

Data lines 501 also connect to the charger 505 via 520 and voltage smart voltage regulator 503 via 521, and enable applications of a smart cell phone 300 to interface with the case. In some embodiments, the communication link 520 between the data lines and the charger 505 is used to turn ON or OFF the charging function of the case. This capability can be leveraged as a smoking cessation tool. For example, in the USE APP, the user can specify that he/she wishes to limit the puffs available for use each day. The application can then modulate the function of the charger 505 to permit only a limited amount of charge to flow into the e-cig 100 via 510 each day.

In some embodiments, the communication link 521 between the data lines and the smart voltage regulator 503 can be used to interrogate the charge status of the e-cig. The smart voltage regulator has an A/D convertor which senses the voltage of the battery, digitizes it, and passes this over the data lines 501 to the cell phone 300. In the phone, these data are decoded to show how much charge is remaining in the e-cig.

In some embodiments, the communication link between the data lines and the smart voltage regulator 503 are used to divert energy from the e-cig 100 to charge the cell phone. In an application on the cell phone, the user can select a function to divert a prescribed charge from the e-cig to the mobile phone. These data flow into the case through the data lines 501 and communication with the smart regulator 503. The smart regulator then opens switch 504 to permit charge to flow from the e-cig to charge the phone.

In some embodiments, the communication link 520 between the data lines and the charger 505 is used to divert energy from the cell phone 300 to charge the e-cig 100. In an application on the cell phone, the user selects a function to divert a prescribed charge from the phone to the e-cig. These data flow into the case through data lines 501, and communicate with the charger 505. The charger 505 then permits charge to flow from the power lines into the battery.

In some embodiments, communications between the common case and the cell phone occur via a wired data link as shown 501, 520, and 521. In some embodiments, these data lines feed into a wireless radio module—such as low-power Bluetooth radio—that then communicates with the cell phone or tablet through standard wireless protocols. This approach has certain benefits because the communication paradigm could be used throughout a broad range of mobile devices that all implement the common wireless communication standard.

FIG. 5 is a continuation of the electrical block diagram in FIG. 4 that shows an alternate charging path to charge the e-cig when no external electrical power is available at the external connector 500b. This alternate path taps the battery power of the cell phone 300 at the cell phone's headphone jack 320 and directs it to the e-cig via a pair of wires 511, a headphone jack power extractor circuit 515, wires 512, an e-cig charging circuit 505, and wires 510.

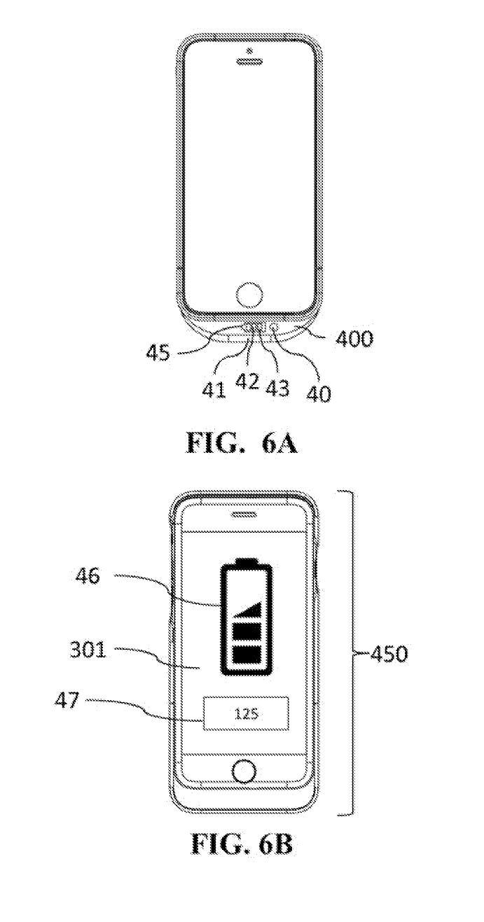

FIG. 6A shows the common case previously shown in FIG. 3B with an added feature to monitor the charge status of an e-cigarette 100 or e-cigar 150 (not shown because they are located on the back of this case). This charge status feature consists of small button switch 40 that when pressed down and held causes a combination of green LEDs 41, 42, and 43 to turn on until the switch 40 is released. These three LEDs are located inside of a permanent drawing 45 on the outer surface of the common case 400 that depicts the outline of a battery. When switch 40 is depressed and all three green LEDs turn on, this indicates that the e-cig is fully charged. When 2 of the LED's turn on, the charge state of the e-cig is between 66% and 100%. One illuminated LED signifies a charge of 33% to 66% and no illuminated LEDs correspond to a 0% to 33% charge state. When the e-cig is connected or disconnected from the common case, the LED indicator may automatically illuminate for a brief period of several seconds to show the charge state of the e-cig battery. Of course, more than three LEDs (41, 42, and 43) may also be used to more precisely characterize the e-cig battery's charge status.

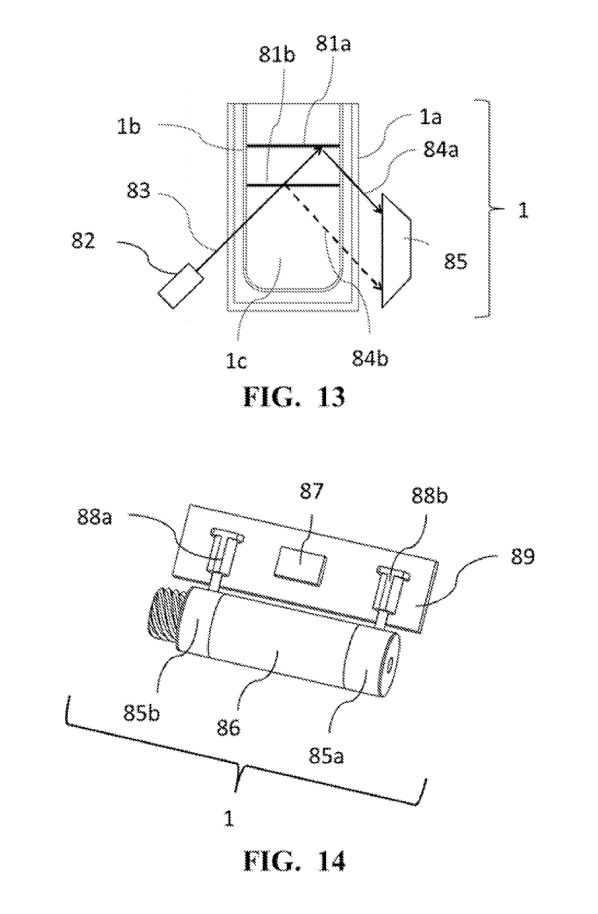

FIG. 6B shows an alternate way of displaying the charge status 46 of the e-cig battery directly on the cell phone viewing screen 301. Also shown on this screen is an optional display 47 of the total number of puffs made by the user employing the current e-cig cartridge. Data used as in input to for this display can be communicated from circuitry monitoring the e-cig battery component and cartridge component over a wired data link located within the common case or by a wireless link such as low-power Bluetooth data link. See the discussion, below, related FIG. 13 and FIG. 14, for information on how monitoring of the fluid level can be converted into number of puffs.

FIG. 7 is a perspective view of a circuit board 600 that provides electrical connectivity between the external micro-USB connector 51 that connects to (1) an external voltage power source (not shown), (2) the internal micro-USB connector 52 that, in turn, connects to the cell phone (not shown), and (3) the e-cig battery component 2. The physical connection between the circuit board 600 and the battery component is made employing two pogo connectors 53 and 54 that are permanently fixed to the circuit board that make contact to the e-cig when it is positioned as shown in this drawing. The name “pogo connector” derives from having a design similar to a child's pogo stick with an internal spring (not shown) inside of the connector's cylindrical body that presses a small electrical conducting ball firmly against the battery component 2. Pogo connector 54 makes electrical contact to the positive pole of the battery 2 while pogo connector 53 makes electrical contact to the negative pole of the battery 2 by contacting the cylindrical surface of the battery 2. Since the surface of battery component 2 is often covered with white paint to simulate white paper on a regular cigarette, this paint must either be made to be electrical conductive or a narrow strip of that paint must be removed around the battery component's circumference as shown in location 55 to expose a metallic surface that is electrically connected to the battery's negative pole.

With the capability of making electrical connection to the e-cig battery component with pogo connectors or some other means, the voltage of the e-cig battery component may be frequently monitored and its value may stored in a buffer electronic memory located within a smartphone sharing the common case such that the last battery voltage value before the e-cig is removed from the common case and the first battery voltage value after the e-cig is reinserted into the common case will be saved by the smartphone and be used to determine, by a calculation, the total battery energy used during an e-smoking episode. This information may be converted by a use monitoring application (USE APP) that is downloaded into the smartphone to display on the smartphone's screen the effective number of conventional tobacco cigarettes that would have been smoked to provide the same amount of nicotine per day or per week as consumed with the e-cig usage. Alternatively, the usage information could be displayed on the smartphone's screen using some other easily understood units corresponding to e-cig usage over time, at the user's request.

The USE APP described above may also include a feature for the user to optionally specify the specific cartridge type being used or nicotine concentration in the fluid solution within the cartridge actually being used if different from a typical average value (say, 16 mg/di) so that the conversion of the e-smoking usage into an equivalent number of conventional tobacco cigarettes smoked would be more accurate.

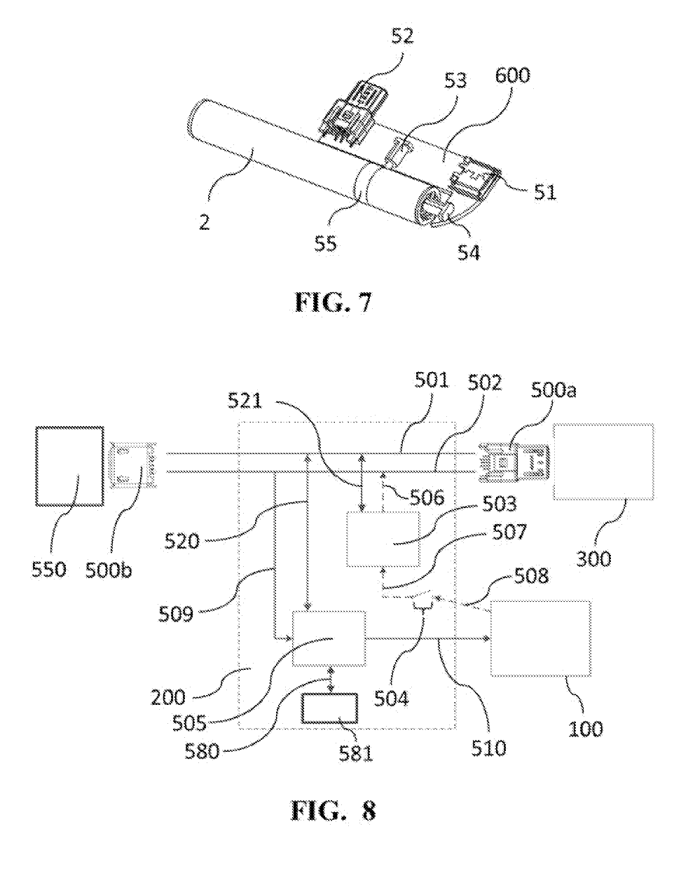

FIG. 8 is a continuation from FIG. 4 and shows a common case embodiment that includes an integral electrical storage device 581. This storage device is a battery or ultra-capacitor that connects to the charging circuit 505 via wires 580. When an e-cig 100 is inserted into the common case after use, energy from the storage device 581 is routed through the charge controller and wires to replenish the e-cig battery.

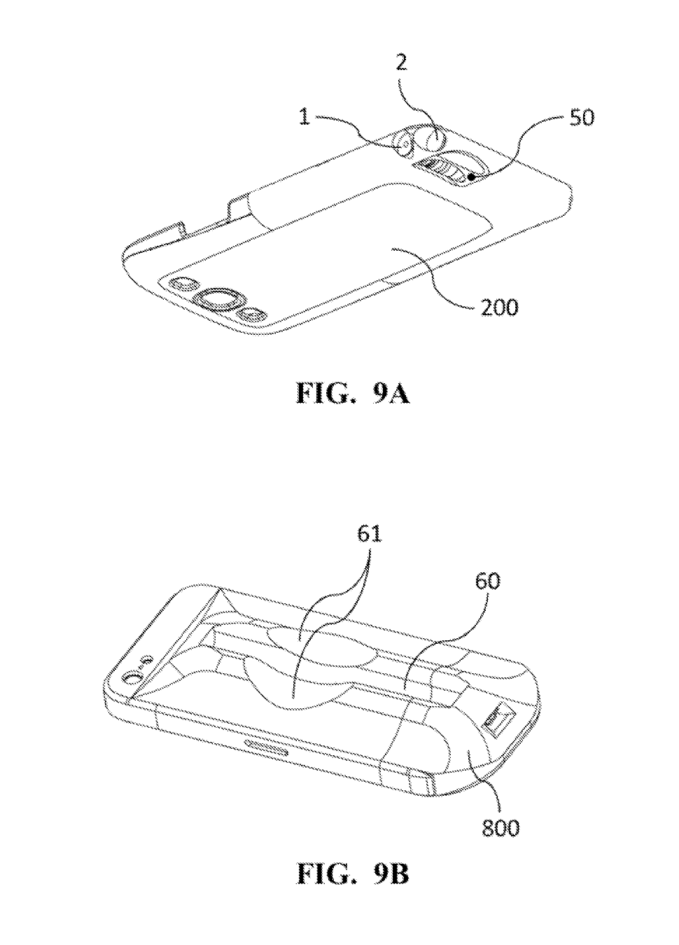

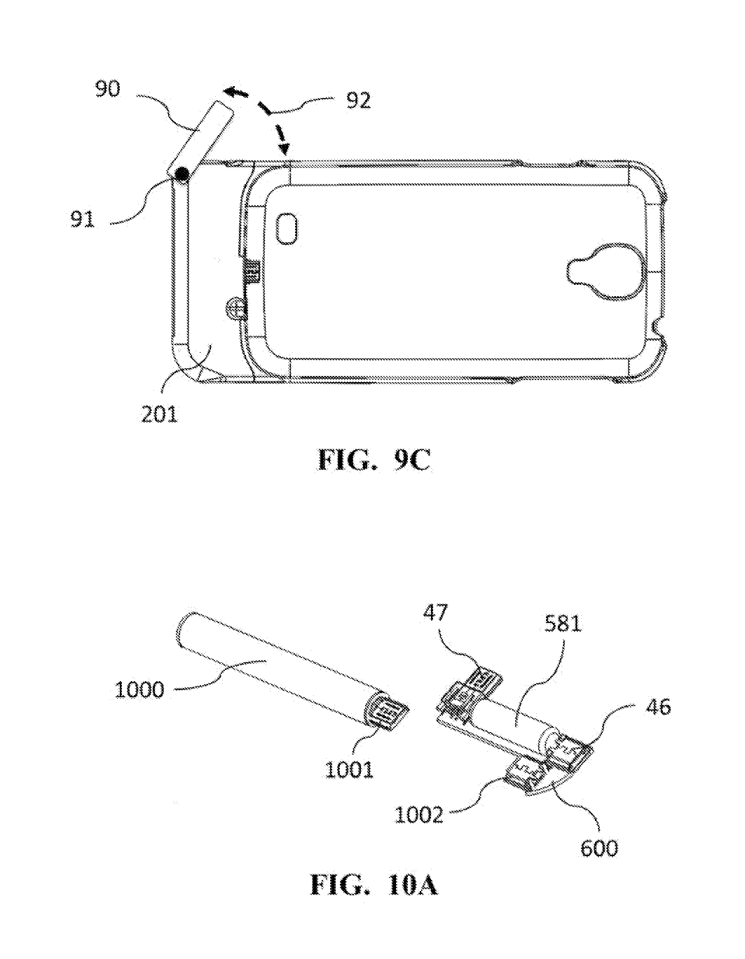

FIG. 9A shows one of several possible ways to retain an e-cigarette 100 or the e-cigarette's battery component 2 and its cartridge component 1 in place. In this drawing, both the battery component 2 and the cartridge component 1 have a friction fit into the common case 200. A cut-out 50 on the back side on the common case 200 is sized so that the user can exert finger pressure on either the battery component 2 or the cartridge component 1 along with motion transverse to the direction of pressure to overcome the friction fit and thereby force either of the component's ends to slide out of the common case. Once the end of a component is out of the case, the user can pull the component entirely free from the case.

FIG. 9B. Shows a cavity 60 on the back of a common case 800 that can hold a single e-cigarette. The narrow transverse opening of the cavity 60 is slightly smaller than the diameter of the e-cig 100. But, the cavity, itself, is sized to comfortably fit the entire e-cig once it is fully inserted into place. The user can press fit his/her e-cig 100 into the cavity 60 and it will be firmly held in place by the narrow restrictive cavity opening. To remove the e-cig 100 from the cavity, there are two zones of relief 61 on the sides of the cavity 60 so that the user can get a firm finger grip on the e-cig 100 and pull it free from the cavity 60 when he/she is ready to use the e-cig.

FIG. 9C shows another means for holding an e-cigarette's battery component 2 (not shown) and cartridge components 1 (not shown) in place in the common case 201 while being stored. There is a small cover 90 over the two openings (not shown) for the removal of the e-cig cartridge component 1 (not shown) and battery component 2 (not shown) that can swing following arrows 92 either to an open or closed position. When closed, the cover 90 fits snuggly around the top and bottom surfaces of the common case 201 with a friction fit so that it stays in place until the user employs sufficient finger force to open the cover 90.

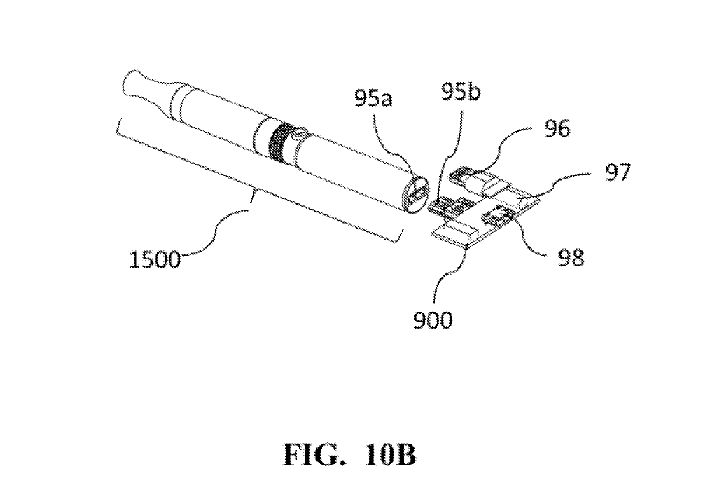

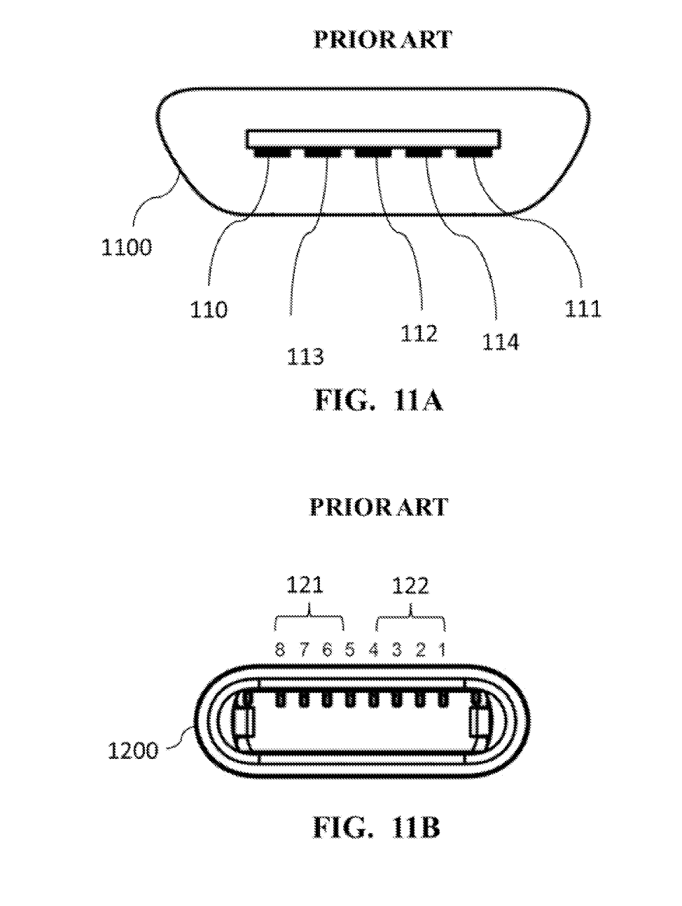

FIG. 10A shows an arrangement different from FIG. 7 for retaining and charging an e-cigarette's battery. FIG. 10A shows a means of retaining an e-cigarette's battery component 1000 (different from the battery component 2 shown in FIG. 1A) that has a micro-USB connector 1001 on its end having a positive electrical contact. This battery end is attached to the printed circuit board 600 by means of a micro-USB connector 1002. In this embodiment, charging of the e-cigarette's battery component 1000 is accomplished through the micro-USB connector 1001 rather than the pogo connectors (parts 53 and 54 in FIG. 7). When the e-cigarette's battery 1000 is inserted into the common case, its micro-USB connector (plug) 1001 slides into the micro-USB socket 1002 on the printed circuit board that is integral with the common case (not shown in this figure). This serves as the electrical connection for charging purposes and also as a mechanical means of retaining the e-cigarette's battery 1000 within the common case (not shown).

FIG. 10B shows a retention and charging arrangement for an e-cigar 1500 adapted with a female micro-USB connector port 95a using a printed circuit board 900 that is incorporated into a common case. The printed circuit board 900 supports a male micro-USB connector 95b that can be inserted into the connector port 95a on the e-cigar 1500, a proprietary connector 96 to mate with an Apple iPhone 6 (not shown), a supplemental battery 97, and an external micro-USB connector 98 that can mate with an external battery charger (not shown) when needed.

FIG. 11A shows a view of entry port 1100 on a micro-USB connector that shows all five of this connector's electrical contacts 110, 111, 112, 113, and 114. By convention (for most cell phones-excluding Apple phones), contact 110 is allocated to a positive 5 Volt operating or charging source, contact 111 is allocated to a zero voltage (ground), and contacts 112 and 113 are dedicated to positive and negative data signals, respectively. Typically, contact 114 remains unused. A micro-USB connector like the one shown in FIG. 11 is used to make the following different types of electrical connections: (1) between a common case and an e-cig, (2) between a common case and an external device such as a battery charger, and (3) between a common case and a cell phone (excluding Apple phones).

FIG. 11B shows a view of the entry port 1200 of a proprietary Apple iPhone 6 connector known as a Lightening Connector. Since only four electrical contacts are required for (1) 5 Volts, (2) ground, (3) positive data, and (4) negative data, male and female Lightening Connectors may be interconnected using either the four electrical contacts 121 on the left hand side of the entry port 1200 or the four electrical contacts 122 on the right hand side of the entry port 1200. The advantage of the Lightening Connector over the micro-USB connector shown in FIG. 11A is that male and female connector ends can be joined without regard for their up or down orientation.

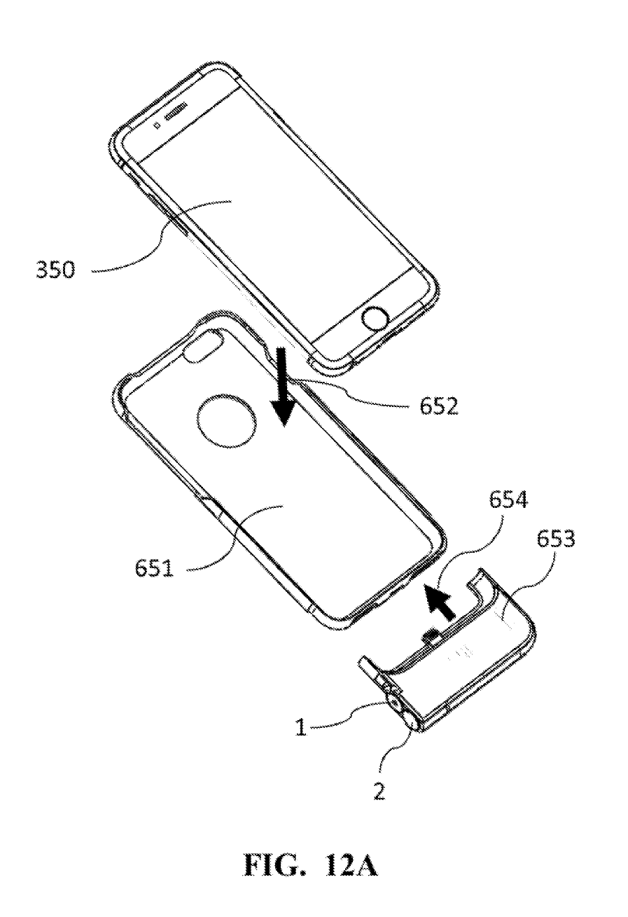

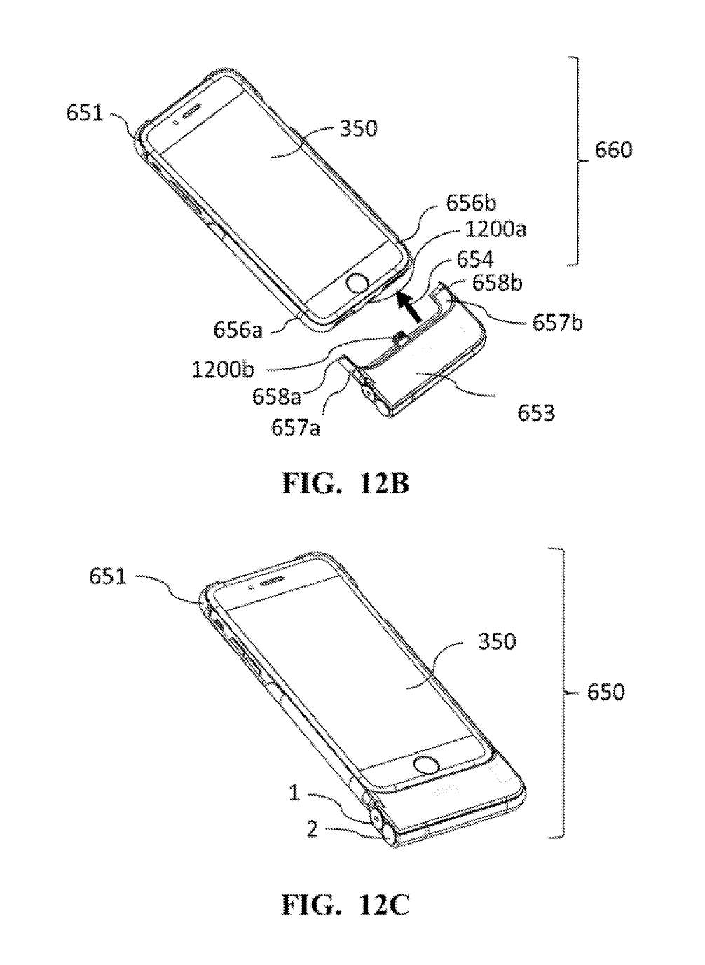

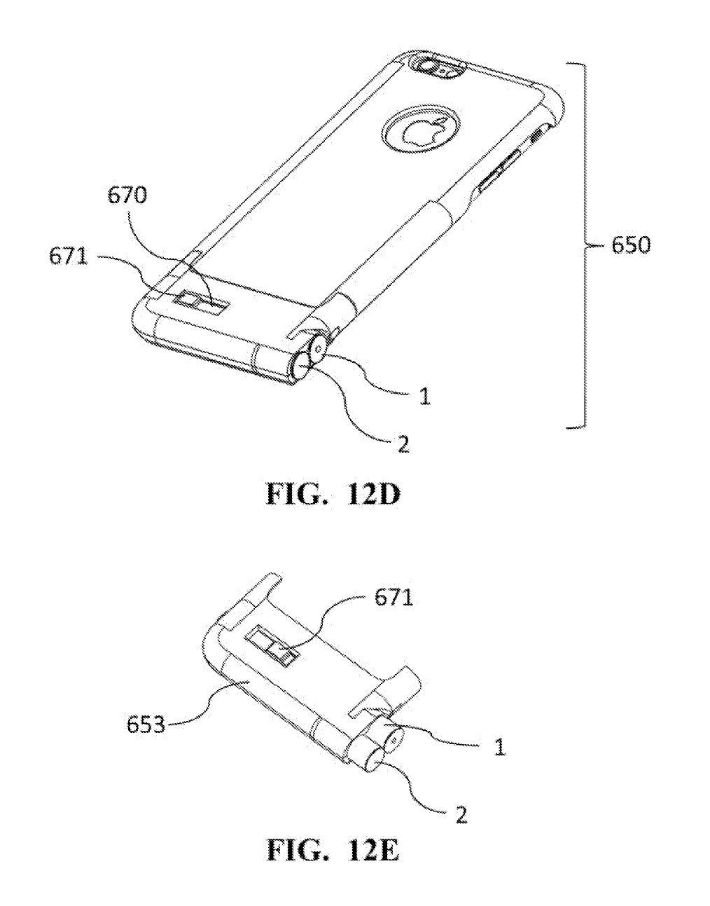

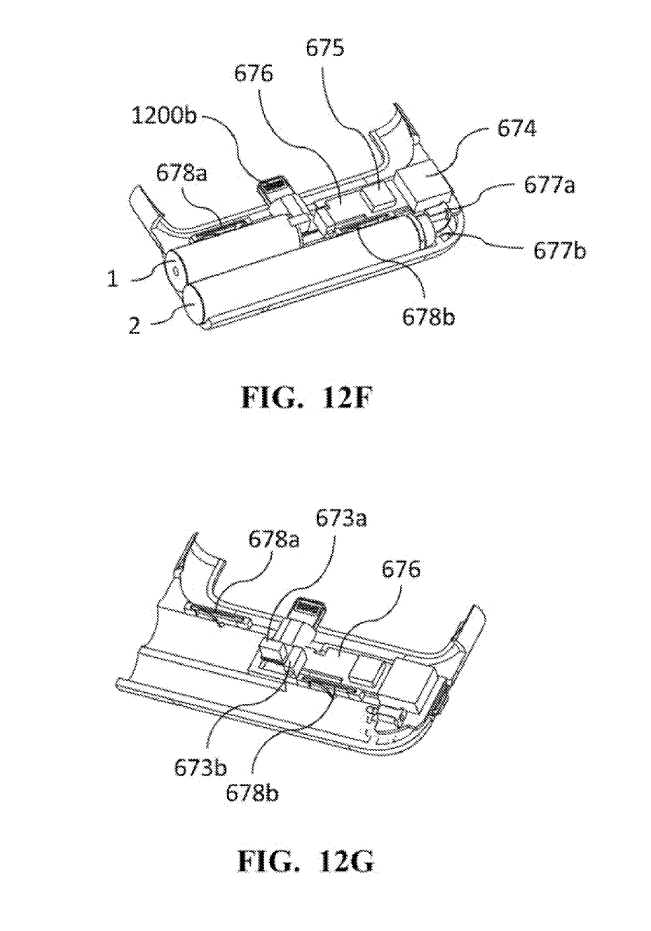

FIG. 12A shows an exploded perspective view of an alternative common case 651 into which an Apple iPhone 6 350 may be inserted in the direction of the arrow 652 and a detachable e-cigarette module 653 may be inserted in the direction of arrow 654.

While the detachable e-cigarette module in this figure has been designed to be attached below the cell phone, in other embodiments a detachable module with similar functional features can hold either e-cigarettes or e-cigars and can be located above the cell phone, to the left or right of the cell phone or behind the cell phone. In the case where the detachable module is located behind the cell phone, it would have a visual appearance similar to that shown in FIG. 3F when attached and this module would hold an e-cigar.

FIG. 12B Shows the iPhone 6 350 fully inserted into the common case 651 forming a case/phone subassembly 660 while the detachable e-cigarette module 653 remains unattached. When the detachable e-cigarette module 653 is moved in direction of arrow 654 it secures the case/phone subassembly 660 with the male Lightening Connector 1200b passing through an opening in the common case 651 to connect directly to the female Lightening Connector 1200a on the bottom side of the iPhone 6 350. The arms 657a and 657b on the left and right hand side of the detachable e-cigarette module 553 each have an internal protrusion 658a and 658b, respectively, that securely fit into channels 656a and 6565b on the left and right hand sides of the common case 651 when the detachable module 653 is properly secured to the case/phone subassembly.

FIG. 12C shows a perspective view of the common case 651, the iPhone 6 350, and the detachable e-cigarette module 653 all joined together to form a completed assembly 650.

FIG. 12D is a perspective back view of the completed assembly 650. When the slider 671 is moved in the channel 670 located on the bottom surface of the detachable e-cigarette module 653 with the force of a user's finger from the position shown in this figure to the right, the e-cigarette cartridge 1 and e-cigarette battery 2 move partially out of the module 653 (as shown in FIG. 12E) where they can be gripped and then fully removed from this module by pulling.

FIG. 12E is a perspective view of the e-cig module shown in FIG. 12D with the slider 671 moved fully to the right so as to cause the e-cig battery 2 and cartridge components 1 to be partially extended out of the e-cig module 70 so that they can be grasped by a user and pulled free of the detachable e-cigarette module 653.

FIG. 12F is a perspective view of the internal portion of the detachable e-cigarette module 670 shown in FIG. 12A that exposes printed circuit board 676, a microprocessor 675, a supplemental battery 674, spring clip 678a to hold the e-cigarette cartridge 1 in position, and spring clip 678b to hold the e-cigarette battery securely in position until the slider 671 (not shown in this figure) is moved.

FIG. 12G is a perspective view similar to that in FIG. 12F but with the e-cigarette's cartridge 1 and battery 2 removed. This exposes sensors 673a and 673b used for sensing the presence (or absence) of the e-cigarette cartridge 1 and e-cigarette battery 2, respectively. These sensors 673a and 673b could simply be electrical switches that open when the e-cigarette cartridge 1 or e-cigarette battery 2 is removed and closed when these e-cigarette components are returned. Alternatively, these sensors might electronically read RFID (radio frequency identification) tags, data on a magnetic strip or product bar codes attached to these components to gain additional information on the type of e-cig cartridge 1 and e-cig battery 2 that is currently being used. Sensor 673a may also include an optional optical means to sense the liquid level in the fluid solution chamber 3 (see FIG. 1A) as shown in FIG. 13. As in the alternative e-cigarette common case previously shown in FIG. 7, pogo connectors 677a and 677b are used to make electrical connection to the positive and negative poles of the e-cigarette battery 2.

FIG. 13 is a cross-sectional view of the proximal end of an e-cig cartridge 1 showing an example of an optical sensor means for determining the liquid level in a solution container 1b. When the solution level is high, a laser beam 83 emitted from a solid state laser 82 is reflected off of the solution's surface 81a in direction 84a to a linear photodetector array 85. When the solution level is lower, the same laser beam is reflected off of the lower liquid surface 81b as beam 84b which arrives at a lower location in the photodetector array 85. The arrival position of the laser beam on the photodetector array 85 can then be used to infer the solution level whenever the e-cig cartridge happens to be in a vertical or near vertical orientation (say within 15 degrees of true vertical). Verticality can be determined by the output of a tilt sensor associated with ae smart phone's display screen. In order for this measurement technique to be viable, it is necessary that the side wall of the solution container 1b is transparent to the laser beam and the side wall 1a of the e-cig cartridge is at least partially transparent to the laser beam. One way to achieve partial transparency is by using a periodic array of very small holes in the e-cig cartridge's wall 1a that are overlaid by a transparent film.

FIG. 14 is a perspective view showing an arrangement for an alternative means for measuring the amount of fluid remaining in the e-cig cartridge 1. The e-cig cartridge 1 is made of an electrically insulating cylinder 86 terminated at both ends by electrically conductive electrodes 85a and 85b. When the e-cig cartridge 1 is inserted into an e-cig module, such as module 653 shown in FIG. 12A, the electrically conductive electrodes 85a and 85b are contacted by pogo connectors 88a and 88b that are mounted on a printed circuit board 89 that also supports a microprocessor 87. The function of the microprocessor 87 is to periodically measure the electrical resistance between the two conductive electrodes 85a and 85b. If the fluid solution is suspended in a cotton (non-conductive fibrous material) matrix, as is typically used, that is in direct contact with the electrodes 85a and 85b, then the measured electrical resistance will be that associated with the fluid solution which is known to be electrically conductive. This measured resistance is inversely proportional to the amount of remaining fluid solution in the e-cig cartridge 1. If the fluid solution is contained within a vial located within the e-cig cartridge 1, a similar measurement of electrical resistance can be made to determine the remaining amount of fluid solution if the electrodes 85a and 85b are made to extend into the vial containing the fluid solution. In order to ensure reproducible resistance measurements, it may be necessary to restrict the measurement to time intervals when the e-cig cartridge 1 happens to be in a predetermined orientation (say, within 15 degrees of horizontal or vertical) as determined by a data signal from the tilt sensor (not shown) associated with the modular smartphone's display screen.

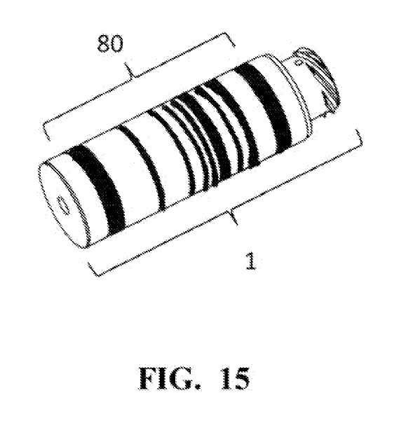

FIG. 15 shows a barcode 80 printed on the outer circumference of the cartridge component 1. This barcode can be optically read when this cartridge component 1 is moved past the barcode reader head when the cartridge component 1 is inserted into the a common case as the one shown in FIG. 9A or the e-cig detachable module shown in FIG. 12A. Use of a circumferential barcode 80 is advantageous because it will be correctly read regardless of the orientation of the e-cig cartridge component during insertion. If a barcode is printed on the outer surface of the cartridge component 1, it may be advantageous to print the barcode using invisible ink that can only be read in the infrared or ultraviolet portions of the optical spectrum so that the visual appearance of the e-cig is not compromised by the barcode's presence. Suitable infrared and ultraviolet inks are commercially available and are described in a Wikipedia article titled INVISIBLE INK that can be found on the Internet. Since the user puts the cartridge component into his/her mouth during e-smoking, it may be desirable to coat the barcode ink on the cartridge component with a transparent film of chemically inert material such as a film of perfluoroalkoxy (PFA) or some other similar material that would be transparent to the optical wavelength used by the barcode reader.

While the above disclosure describes several specific examples of common cases used to hold, protect, and recharge one or more e-cigs and a cell phone or tablet, these examples should merely be considered to be representative of many other configurations for accomplishing the desired objectives of holding, protecting and recharging. It is therefore to be understood that the scope of this invention is broader than specifically described in the specification and following claims and that the apparatus and methods described herein relate broadly to the integration of e-cigs and cell phones or tablets through the use of a common case.

The invention claimed is:

1. A common case that can be used to hold, protect, and simultaneously recharge one or more e-cigs and a cell phone or tablet.

2. A common case as in claim 1 that is made from an impact resistant plastic part(s).

3. A common case as in claim 1 that includes an integral electrical connector on its outer surface suitable for connecting to an external battery charger.

4. A common case as in claim 1 that can hold one or more e-cigs that are either fully assembled or separated into battery and cartridge components.

5. A common case as in claim 1 that has an internal electrical connector that mates to the input electrical connector of a cell phone or tablet.

6. A common case as described in claim 1 that is made from a single injection molded plastic part.

7. A common case as described in claim 1 that is made from two or more injection molded plastic parts.

8. A common case as described in claim 1 that has an internal printed circuit board (PCB).

9. A common case as described in claim 8 having a connector fixed to the PCB that can make connection to an external battery charger.

10. A common case as described in claim 8 having a connector fixed to the PCB that makes connection to a cell phone or tablet.

11. A common case as described in claim 8 having two pogo connectors attached to the PCB that make electrical contact to battery of an e-cig.

12. A common case as described in claim 8 having a micro-USB connector attached to the PCB that makes connection to a mating micro-USB connector attached to the battery of an e-cig.

13. A common case as described in claim 8 having a charging circuit for an e-cig mounted on the PCB.

14. A common case as described in claim 8 having a charging circuit for a cell phone mounted on the PCB.

15. A common case as described in claim 8 having a charging circuit for a cell phone that includes a boost regulator to achieve an output level of 5 Volts mounted on the PCB.

16. A common case as in claim 12 that includes an electrical wire connection from the headphone jack on the cell phone to the e-cig charging circuit.

17. A common case as in claim 12 that includes a display on the case's external surface that can show the charge status of an e-cig battery.

18. A common case as in claim 17 where the display consists of three (3) or more side-by-side light emitting diodes (LEDs) and a push button switch that, when held down, causes a varying number of the three or more LEDs to turn on in a direct relation to the charge status of the e-cig.

19. A common case as in claim 12 containing a smart cell phone that can display the charge status of the e-cig's battery on the screen associated with the smart cell phone employing a user application that is downloaded into the smart cell phone.

20. A common case as in claim 12 containing a smart cell phone that can display the number of puffs a user has taken on the e-cig cartridge in the common case by employing a user application that is downloaded into the smart cell phone also in the common case.

21. A common case as in claim 4 where the e-cig and/or the e-cig battery and cartridge components are held in place by a friction fit in a cylindrical cavity or cavities.

22. A common case as in claim 21 that includes a cut-away section such that the e-cig and/or the e-cig battery and cartridge components can slid out of the common case with finger pressure and simultaneous finger motion transverse to the direction of pressure.

23. A common case as in claim 4 where the e-cig and/or the e-cig battery and cartridge components are held in place by a press fit into a cavity having an opening slightly smaller than the diameter of the e-cig or its components and an inside diameter slightly larger than the e-cig or its components.

24. A common case as in claim 20 where the e-cig and/or the e-cig battery and cartridge components can be removed by gripping with the user's fingers in a zone where the sides of the cavity have been relieved and then pulling the e-cig or e-cig components free.

25. A common case as in claim 4 where the e-cig and/or the e-cig battery and cartridge components can be removed by opening a small door that is attached to the common case with a hinge.

26. A common case as in claim 25 in which the small door is held securely closed with a friction fit to the top and bottom surfaces of the common case and can be opened with finger force.

27. A common case that can be used to hold, protect, and simultaneously recharge one or more e-cigs and a cell phone or tablet that includes within the common case a supplemental rechargeable battery or other electrical storage device, such as an ultracapacitor, that can be recharged simultaneously with the recharging of one or more e-cigs and a cell phone or tablet.

28. A common case as in claim 26 that includes electrical circuitry including user activated switches that permit the user to redistribute the electrical power stored in the supplemental battery to either the e-cig battery or to the cell phone (or tablet) battery or to both.

29. A common case made from impact resistant plastic that can be used to hold, protect, and simultaneously recharge one or more e-cigs and a cell phone or tablet that includes a PCB located in the case's interior that has electrical connectors affixed that can connect to (1) an external battery charger, (2) a cell phone or tablet, and (3) one or more e-cigs.

30. A common case made from impact resistant plastic that can be used to hold, protect, and simultaneously recharge (1) one or more e-cigs, (2) a cell phone or tablet and (3) a supplemental battery located in the case's interior along with a PCB also located in the case's interior that has electrical connectors affixed that can connect to (1) an external battery charger, (2) a cell phone or tablet, (3) the supplemental battery, and (4) one or more e-cigs.

31. A common case that can be used to hold, protect, and simultaneously recharge a cell phone or tablet and one or more e-cigs located in a detachable module that can be mechanically connected or removed from the remaining portion of the common case that holds the cell phone.

32. An e-cig in a common case as in claim 4 or a detachable module as in claim 31 in which the electrical energy stored in the e-cig battery component or supplemental battery or ultra-capacitor can be shared, bi-directionally, with the electrical energy stored in the main battery in the cell phone at the user's discretion.

33. An e-cig in a common case as in claim 4 or a detachable module as in claim 31 that includes an e-cig battery component sensing electrical switch that is closed when an e-cig battery component is present and is open when the e-cig battery component is removed.

34. An e-cig in a common case as in claim 4 or a detachable module as in claim 31 in which the voltage of the e-cig battery component part is frequently monitored and its value is stored in a buffer electronic memory within a smart cell phone such that the last battery voltage value before the e-cig is removed from the e-cig module and the first battery voltage value after the e-cig is reinserted will be saved and be used to determine, by a calculation, the total battery energy used during an e-smoking episode and, if desired, be converted by a use monitoring application (USE APP) in the smart cell phone to display on the smart cell phone screen the effective number of conventional tobacco cigarettes that would have been smoked to provide the same amount of nicotine per day or per week as consumed with the e-cig usage or alternatively displaying some other easily understood units corresponding to e-cig usage over time at the user's request.

35. A USE APP as in claim 34 which includes a feature for the user to optionally enter into the smart cell phone the specific cartridge type being used or the nicotine concentration in the fluid solution within the cartridge actually being used if different from a typical average value (say, 16 mg/dl) so that the conversion of the e-smoking usage into an equivalent number of conventional tobacco cigarettes smoked would be more accurate.

36. A common case as in claim 8 or a detachable module as in claim 31 that includes an integral optical scanner that can read an identifying bar code printed on the outer cylindrical surface of the cartridge when the cartridge is inserted into the common case or e-cig module along with a USE APP that can convert the bar code information into a cartridge type and/or nicotine concentration level to eliminate the need for the user to manually enter this information into the USE APP.

37. An optical barcode scanner as in claim 36 operating in the infrared portion of the optical spectrum to read infrared ink that is not visible to a human eye to preserve the appearance of the e-cig cartridge component.

38. An optical barcode scanner as in claim 36 operating in the ultraviolet portion of the optical spectrum to read ultraviolet ink that is not visible to a human eye to preserve the appearance of the e-cig cartridge component.

39. A common case as in claim 8 or a detachable module as in claim 31 that includes an integral magnetic strip scanner that can read a magnetic data code written on a strip that is bonded to the outer cylindrical surface of the e-cig cartridge so that when this cartridge is inserted into the common case or detachable module a USE APP can convert the magnetic information into a cartridge type and/or nicotine concentration level to eliminate the need for the user to manually enter this information into the USE APP.

40. A common case as in claim 8 or a detachable module as in claim 31 that includes a proximity sensor that can read an RFID tag that is inside or bonded to the cylindrical surface of the e-cig cartridge so that when this cartridge is inserted into the e-cig common case or detachable module a USE APP can convert the RFID tag information into a cartridge type and/or nicotine concentration level to eliminate the need for the user to manually enter this information into the USE APP.

41. A common case as in claim 8 or a detachable module as in claim 31 that includes an optical sensor that can be used in conjunction with the output of a tilt sensor associated with the smart cell phone's display screen to determine the fluid solution level in the container located in the e-cig cartridge.

42. A common case as in claim 8 or a detachable module as in claim 31 that includes an electrical resistance sensor that can be used in conjunction with the output of a tilt sensor associated with the smart cell phone's display screen to determine the amount of fluid solution in a fibrous non-conductive matrix, such as cotton, or in a non-conductive fluid container located in the e-cig cartridge.

43. An e-cig module as described in claim 8 having two pogo connectors fixed to the printed circuit board that make connection to the battery of an e-cig.

44. An e-cig module as described in claim 8 having two pogo connectors fixed to the printed circuit board that make connection to the cartridge of an e-cig.

45. An e-cig common case as in claim 1 or a detachable module as in claim 31 including a mechanical slider that when moved by the user's application of lateral finger force causes the e-cig battery and cartridge components to partially extend outside of the common case or module so that the e-cig battery and cartridge components can be gripped by the user.

46. An e-cig common case as in claim 8 or a detachable module as in claim 34 in which data can be communicated between the e-cig and the cell phone using either electrical wires or by wireless low-power Bluetooth signaling.

47. An e-cig common case as in claim 8 where e-cig charging can be turned on or off based on communication received from the cell phone or tablet.
